(19) United States
(12) Patent Application Publication
(10) Pub. No.: US 2002/0023161 A1
(43) Pub. Date: Feb. 21, 2002

(54) Load dispersion-type duplex communication system and duplex transmission device

(76) Inventor: Kousaku Ito, Tokyo (JP)

Correspondence Address: McGinn & Gibb, PLLC, Suite 200, 8321 Old Courthous Road, Vienna, VA, 22182-3817, US

(21) Appl. No.: 09/929,106

(22) Filed: Aug. 15, 2001

(30) Foreign Application Priority Data
Aug. 18, 2000 (JP) 2000-248578

(51) Int. Cl. G06F 15/16

(52) U.S. Cl. 709/229

(57) ABSTRACT

A load dispersion-type duplex communication system and duplex transmission devices are provided which are capable of preventing a communication limitation, instantaneous interruption, and/or break-down of communications, system-down that cause decreases in communication quality.

Whether each of transmission devices is in an overload state or in an allowable load state is judged. The transmission device being judged to be in the allowable load state performs duplex operation with another transmission device and the transmission device being judged to be in the overload state performs single and work-dividing operation with another transmission device. A load detecting section notifies a controller of a result state by comparing data storage capacity in a memory section with a threshold value. When the transmission device is in the single and work-dividing operation mode, low-order transmission devices synthesize and process data.

### BACKGROUND OF THE INVENTION

1. Field of the Invention

The present invention relates to a load dispersion-type duplex communication system and a duplex transmission device.

The present application claims priority of Japanese Patent Application No. 2000-248578 filed on Aug. 18, 2000, which is hereby incorporated by reference.

2. Description of the Related Art

Generally, a conventional duplex transmission device is a transmission device so configured as to have two transmission devices with same configurations, one serving as an operating system and an other serving as a standby system. In ordinary cases, data fed from a high-order transmission device on a transmission path is transmitted to both the operating system and the standby system in the same manner. If a failure occurs in the operating system, the system is switched and the system that had served as the standby system starts to operate as a new operating system.

In the conventional duplex transmission device, when each transmission device serving as the operating system receives data exceeding its data storage capacity, any one of following measures is taken:

1. The high-order transmission device is so controlled as to limit the data transmission to the transmission device serving as the operating system.

2. The high-order transmission device is not controlled to limit the data transmission and the transmission device serving as the operating system still continues to process the transmitted data within a possible range.

3. The operating system is judged as being malfunctional and switching is done to the standby system.

However, the above conventional technologies have problems described below. That is, when the high-order transmission device is so controlled as to limit the data transmission to the transmission device serving as the operating system, there is a problem in that time (waiting time) during which a user cannot use communication service increases. When the high-order transmission device is not controlled and the transmission device serving as the operating system continues to process the transmitted data within the possible range, there is also a problem in that a case occurs in which data is discarded, causing the communication to be interrupted instantaneously or to break down while the user is carrying out the communications. Moreover, when the operating system is judged as being malfunctional and the switching is done to the standby system, there is also a problem in that, since the same amount of the data that had been fed to the operating system are transmitted to the standby system all the time, even if the switching is done to the standby system, failure that had occurred in the operating system also occurs soon in the standby system. This causes both the systems to be malfunctional, thus leading even to a system-down in some cases.

Thus, in the conventional duplex transmission device, since an overload occurring temporarily cannot be accommodated, communication limitation, instantaneous interruption and/or break-down of communications, system-down occurs, as a result, causing decreases in communication quality.

Moreover, in the conventional duplex transmission device, to solve the above problem, in order to accommodate the temporary overload, it is necessary to design and use a large-scale device having excessive capacity not required in ordinary states. This causes very costly production. On the other hand, conventionally, there exists a communication system having duplexed configurations with an aim of dispersing a load in a system control device. However, even in this case, there is still a problem in that a heavy load is imposed on the system control device.

### SUMMARY OF THE INVENTION

In view of the above, it is an object of the present invention to provide a load dispersion-type duplex communication system and a duplex transmission device capable of preventing an occurrence of communication limitation, instantaneous interruption and/or break-down of communications, system-down, or a like that cause decreases in communication quality, by dispersing an overload occurring temporarily in a transmission device and of being so configured as to be comparatively small in size to achieve an excellent communication quality. It is another object of the present invention to enable dispersion of a load in each transmission device, in communication systems made up of multi-stage transmission devices, without a judgement and instruction to be provided by a system control device and to achieve easily the dispersion of the load without imposing a large load on the system control device and to provide stable control on the transmission devices.

According to a first aspect of the present invention, there is provided a load dispersion-type duplex communication system including:

duplexed transmission devices;

wherein, whether each of the transmission devices is in an overload state or in an allowable load state is judged and the transmission device judged as being in the allowable load state performs a duplex operation with another transmission device and the transmission device being judged as being in the overload state performs a single and work-dividing operation with the other transmission device.

In the foregoing, a preferable mode is one wherein each of the transmission devices judges, for itself, whether each of the transmission devices is in the overload state or in the allowable load state and does automatically switching between the duplex operation and the single and work-dividing operation.

Also, a preferable mode is one wherein either of data processed by two transmission devices performing the duplex operation is selected and processed by a low-order transmission device on a transmission path and wherein if judged to be in said overload state, data processed by the two transmission devices performing the single and work-dividing operation is multiplexed and processed by a low-order trans-mission device on the transmission path.

Also, a preferable mode is one wherein each of the transmission devices is provided with a unit used to judge whether each of the transmission devices is in the overload state or in the allowable load state and each of the transmission devices, in accordance with a judgement by each of the transmission devices, automatically does switching between the duplex operation and the single and work-dividing operation and then provides an instruction for the switching to another transmission device of a same order on a transmission path and a low-order transmission device on the transmission path.

Also, a preferable mode is one wherein, whether each of the transmission devices is in the overload state or in the allowable state is judged based on a data storage capacity of each of the transmission devices.

Also, a preferable mode is one wherein a control is made in a manner to set an overload threshold value used to judge whether each of the transmission devices is in the overload state or not and an allowable load threshold value used to judge whether the allowable load is below the overload threshold value or not.

Also, a preferable mode is one wherein, whether each of the transmission devices is in the overload state or in the allowable state is judged based on an amount of changes in data storage capacity within a predetermined period of time in each of the transmission devices.

According to a second aspect of the present invention, there is provided a load dispersion-type duplex communication system including :

a received data selecting and multiplexing section;

a memory section used to store, on a temporary basis, data fed from the received data selecting and multiplexing section;

a transmission path interfacing section;

a load detecting section used to compare data amounts accumulated in the memory section with a threshold value; and

a controller used to control each of the received data selecting and multiplexing section, the memory section, the transmission path interfacing section, and the load detecting section in accordance with results of the comparison by the load detecting section and to do switching between a duplex operation and single and work-dividing operation.

With the above configurations, since the transmission device is so configured as to operate in the duplex operation mode, by having the transmission device operate, on a temporary basis, in the single and work-dividing operation mode, the overload occurring temporarily can be dispersed. Therefore, the transmission device has the effect of preventing communication limitation, instantaneous interruption and/or break-down of the communications, system-down that may cause decreases in communication quality.

With another configuration, since the duplexed transmission device can be operated temporarily on the single and work-dividing operation, the communication system assured of excellent communication quality can be configured on a small scale.

With still another configuration, the communication system made up of multistage transmission devices can do switching between the duplex operation and single and work-dividing operation by coordination between controllers in each of the transmission devices, the load dispersion is made possible without the need for receiving judgements and instructions from the system control devices and the load dispersion can be easily achieved without imposing the large load on the system control devices.

With still another configuration, since special threshold value processing is incorporated, more stable control of the transmission device is made possible.

### BRIEF DESCRIPTION OF THE DRAWINGS

The above and other objects, advantages, and features of the present invention will be more apparent from the following description taken in conjunction with the accompanying drawings in which:

FIG. 1 is a schematic block diagram showing configurations of a duplex communication system according to a first embodiment of the present invention;

FIG. 2 is a schematic block diagram showing internal configurations of a transmission device according to the first embodiment of the present invention; and

FIG. 3A is an image diagram explaining an operation of data processing at a time of duplex operation and FIG. 3B is an image diagram explaining an operation of data processing at a time of a single and work-dividing operation.

### DETAILED DESCRIPTION OF THE PREFERRED EMBODIMENTS

Best modes of carrying out the present invention will be described in further detail using various embodiments with reference to the accompanying drawings.

First Embodiment

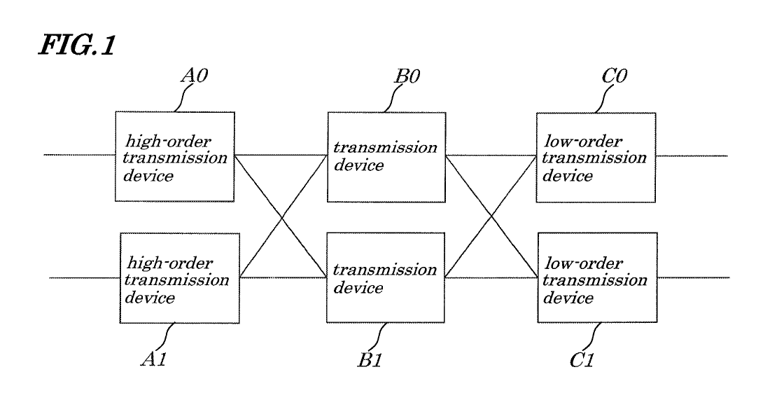

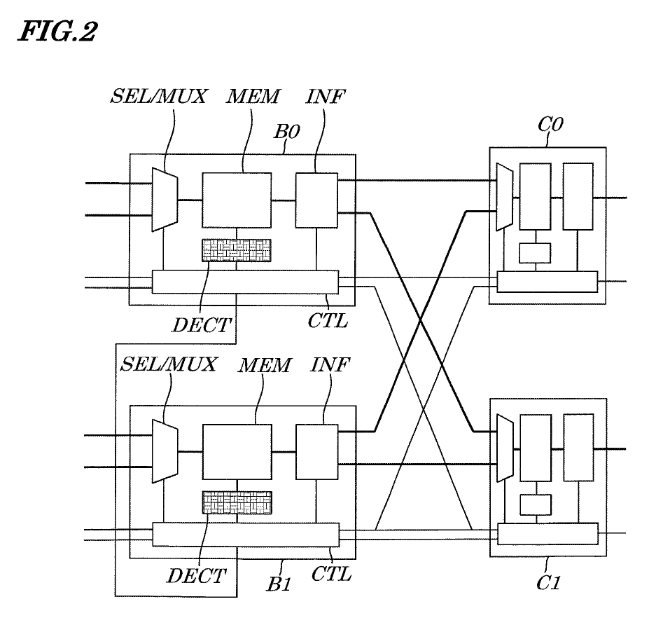

FIG. 1 is a schematic block diagram showing configurations of a duplex communication system according to a first embodiment of the present invention. FIG. 2 is a schematic block diagram showing internal configurations of a transmission device according to the first embodiment. As shown in FIG. 1, the duplex communication system of the embodiment includes high-order transmission devices A0 and A1, transmission devices B0 and B1 and low-order transmission devices C0 and C1 on transmission paths. The transmission devices B0 and B1 are connected to the high-order transmission devices A0 and A1 and to the low-order transmission devices C0 and C1. All the transmission devices A0 to C1 have same configurations. As shown in FIG. 2 except the transmission devices A0 and A1, each of the transmission devices A0 to C1 has a received data selecting and multiplexing section SEL/MUX, a memory section MEM, a transmission path interfacing section INF, a controller CTL and a load detecting section DECT.

The received data selecting and multiplexing section SEL/MUX selects and multiplexes data received from the high-order transmission devices A0 and A1 in accordance with an instruction from the controller CTL. At a time of a duplex operation, the received data selecting and multiplexing section SEL/MUX, in accordance with instruction from the controller CTL, selects the data received from either of the high-order transmission devices A0 or A1 and transmits selected data to the memory section MEM existing at a rear stage. At a time of a single operation, the received data selecting and multiplexing section SEM/MUL, in accordance with the instruction from the controller CTL, multiplexes the data received from both the high-order transmission devices A0 and A1 and transmits the multiplexed data to the memory section MEM existing at the rear stage.

The memory section MEM stores data received from the received data selecting and multiplexing section SEL/MUX on a temporary basis. If the transmission speed is different between the [transmission path between A※-B※] and the [transmission path between B※-C※] (※=0, 1), the data are stored in the memory section MEM on a temporary basis, hereby accommodating a difference in the transmission speed. The transmission path interfacing section INF is an interface device between the memory section MEM and the transmission path. The controller CTL controls each of the above received data selecting and multiplexing section SEL/MUX, the memory section MEM, and the transmission path interfacing section INF. The controller CTL, in accordance with a report fed from the load detecting section DECT, provides an instruction for switching between the duplex operation and single and work-dividing operation to the controller CTL of an other transmission device of a same order on the transmission path. That is, for example, the controller CTL of the transmission device B0 provides the instruction to the controller of the transmission device B1. The controller CTL, in accordance with a report fed from the load detecting section DECT, provides an instruction for switching between the duplex operation and single and work-dividing operation (that is, the instruction for data processing method using either of the multiplexing or selecting method) to the controller CTLs of the low-order transmission devices C0 and C1. Moreover, the controller CTL sets an arbitrary “threshold value”, based on data storage capacity of the memory section MEM, on the load detecting section DECT. The load detecting section DECT, which is specific to the present invention, checks amounts of data accumulated in the memory section MEM and, whenever necessary, compares the checked amounts of data with the above “threshold value” and makes a report on the compared results to the controller CTL, whenever necessary or at an appropriate time.

Next, operations of the communication system will be described by referring to FIG. 2. Operations of the duplex operation at ordinary times will be explained first. Here, let it be assumed that the transmission device B0 and the low-order transmission device C0 are being operated as the current operating system and the transmission device B1 and the low-order transmission device C1 are operated as the standby system. The transmission device B0 operating as the current operating system transmits same data to the low-order transmission devices C0 and C1. The transmission device B0 instructs the controller CTLs of the low-order transmission devices C0 and C1 to select the data transmitted from the transmission device B0 operating as the current operating system, out of the data transmitted by both the transmission devices B0 and B1. The transmission device B1 operating as the current standby system transmits the same data that the transmission device B0 is transmitting to the low-order transmission devices C0 and C1 being the low-order devices in the transmission path. Each of the low-order transmission devices C0 and C1 receives completely the same data from both the transmission devices B0 and B1, however, selects the data received from the transmission device B0 in accordance with the instruction from the transmission device B0 operating as the current operating system.

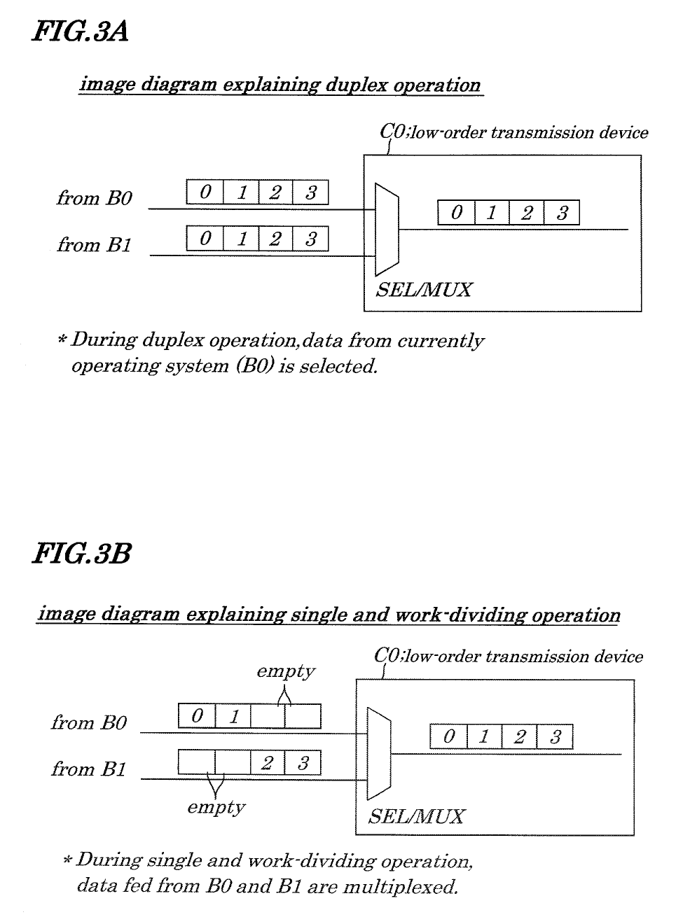

Next, internal operations of the low-order transmission device C0 will be described below. The controller CTL of the low-order transmission device C0, when receiving an instruction for “selection of data from the transmission device B0” from the transmission device B0 operating as the current operating system, instructs the received data selecting and multiplexing section SEL/MUL to select the data received from the transmission device B0. The received data selecting and multiplexing section SEL/MUX of the low-order transmission device C0, in accordance with the above instruction, selects the data received from the transmission device B0 and transmits the selected data to the memory section MEM existing at the rear stage. The memory section MEM of the low-transmission device C0 holds the received data on a temporary basis and transmits, at the appropriate time, the data to the transmission path interfacing section INF existing at the rear stage. The transmission path interfacing section INF converts the data fed from the memory section MEM into the data having a code or a speed that can correspond to the transmission devices existing at the rear stage and transmits the converted data to the transmission devices at the rear stage. FIG. 3A shows an image diagram explaining the operation of the above received data selecting and multiplexing section SEL/MUX in the low-order transmission device C0 being operated in the duplex operation mode. At the time of the ordinary duplex operation, as shown in FIG. 3A, out of the data “0”, “1”, “2” and “3” transmitted from both the transmission devices B0 and B1 after having been processed by both of them, all the data “0”, “1”, “2” and “3” transmitted from the transmission device B0 after having been processed by the transmission device B0 are selected and transferred, without being processed, to the memory section MEM at the rear stage. A series of operations described above are also performed by the low-order transmission device C1 in the same manner as above.

Next, the single and work-dividing operations at the time of an overload, which characterizes the present invention, will be explained below. Here, let it be assumed that the transmission devices A0 and A1 and low-order transmission device C0 are operated as the current operating system and the transmission device B1 and low-order device C1 are operated as the standby system in the duplex operation manner. In the transmission device B0 being operated in the duplex operation manner, in some cases, due to increased amounts of data received from the high-order transmission device A0, increased delay in processing in the transmission path interfacing section INF, decreases in quality of the transmission path between the transmission device B0 and the low-order transmission device C0 or a like, data exceeding the ordinary level is accumulated in the memory section MEM. In such cases, in the conventional technology, discarding of a part of the data and great delay in processing of the data transmission occur, which in some cases leads to a system failure. The present invention solves the above problems by implementing the functions described below.

That is, the controller CTL sets an arbitrary “threshold value” on the load detecting section DECT. The arbitrary “threshold value” denotes the threshold value calculated based on maximum amounts of data that the memory section can store and in this example it is presumed to be a value being “90 percent of the maximum amount”. The load detecting section DECT of the transmission device B0 periodically checks the data storage capacity of the memory section MEM and compares the “checked value” with the “threshold value” set by the controller CTL for detection. When the result obtained by the periodically consecutive comparison and detection is changed from its content that the “checked value (data storage capacity)” is below the “threshold value” to its content that the “checked value (data storage capacity)” exceeds the “threshold value”, the load detecting section DECT informs the controller CTL of the transmission device B0 that the memory MEM is in an overloaded state. On the other hand, when the result obtained by the periodically consecutive comparison and detection is changed from its content that the “checked value (data storage capacity)” exceeds the “threshold value” to its content that the “checked value (data storage capacity)” is below the “threshold value”, the load detecting section DECT informs the controller CTL of the transmission device B0 that the memory MEM is in an allowable load state.

The controller CTL of the transmission device B0 that has received the report that there is the overload is adapted to instruct the controller CTL of the transmission device B1 being another transmission device of an other system to do switching to the single and work-dividing operation. At the same time, the controller CTL of the transmission device B0 provides an instruction for work-dividing operations including contents of divided work for data processing. The contents of divided work for the data processing indicates which data and to what extent should be processed by the transmission device B1, out of data to be received from the high-order transmission device A0 being operated as the operating transmission device serving as the current high-order operating system. Also, at the same time, the controller CTL of the transmission device B0 provides the instruction for switching to the single and work-dividing operation to the controller CTL of the low-order transmission device C0 and to the controller CTL of the low-order transmission device C1.

The transmission device B1, before receiving the above instruction for the switching, as in the case of the transmission device B0, performs the processing of all the data received from the high-order transmission device A0 and transmits the processed data to the low-order transmission device C0 and low-order transmission device C1 at the rear stage. However, the transmission device B1, after having received the above instruction for the switching from the transmission device B0, performs the processing of the data only (that is, a part of data received from the high-order transmission device A0) shown in the above contents of divided work, without performing processing all the data received from the high-order transmission device A0 and transmits the processed data to the low-order transmission devices C0 and C1 existing at the rear stage. The transmission device B0 having provided the instruction for the work-dividing operation performs the processing of the data only other than the data shown in the contents of divided work that the transmission device B0 has instructed the transmission device B1 to undertake and then transmits the processed data to the low-order transmission devices C0 and C1 at the rear stage.

The transmission device B0, thus, by decreasing the amounts of the data to be processed by the transmission device B0 and by having the transmission device B1 process the data in amounts being equivalent to the decreased amount of the data, waits until the data storable amount increases and maintains the single and work-dividing operation until the transmission device B0 receives a report that the memory section MEM of the transmission device B0 has become an allowable load level.

Then, the controller CTLs of the low-order transmission devices C0 and C1 having received the instruction for “switching to the single operation mode” from the transmission device B0 provides an instruction for multiplexing to the received data selecting and multiplexing section SEL/MUX in each of the low-order transmission devices C0 and C1. Each of the received data selecting and multiplexing section SEL/MUX in the low-order transmission device C0 having received the instruction for the multiplexing and the received data selecting and multiplexing section SEL/MUX in the low-order transmission device C1 multiplexes the data fed from the transmission device B0 and the transmission device B1 and transmits the multiplexed data to the memory section MEM at the rear stage. FIG. 3B shows an image diagram explaining the operation of the above received data selecting and multiplexing section SEL/MUX in the low-order transmission device C0 being operated in the single operation mode. At the time of the single and work-dividing operation, as shown in FIG. 3B, the data “0” and “1” processed by the transmission device B0 with the work being shared by the transmission device B0 and the data “2” and “3” processed by the transmission device B1 with the work being shared by the transmission device B1 are selected and multiplexed and the processed data is transmitted to the memory section MEM existing at the rear stage.

The controller CTL of the transmission device B0 having received, from the load detecting section DECT of the transmission device, the report that the load in the memory section MEM is allowable provides an instruction for resetting “single operation mode” on the transmission device B1, low-order transmission device C0 and low-order transmission device C1 and, at the same time, resets the single operation mode of the transmission device B0. Thus, all the transmission devices are restored to the ordinary duplex operation state.

As described above, according to the first embodiment of the present invention, even when the overload exceeding the ordinary level is imposed on the memory section MEM, by performing the single and work-dividing operation described above, normal communication is continued without causing various decreases in communication quality.

Second Embodiment

Operations and configurations of a load dispersion-type duplex communication system and duplex transmission devices of a second embodiment will be described. Configurations and operations of the second embodiment are approximately the same as those in the first embodiment, but differ from those in the first embodiment in following points.

In the first embodiment, a controller CTL sets a threshold value for “detection of an overload state” and a threshold value for “detection of an allowable load state” on a load detecting section DECT so that a “same threshold value” is used for both the detection of the overload state and for the detection of the allowable load state. However, in the second embodiment, the controller CTL sets the threshold value for the “detection of the overload state” and for the detection of the allowable load state so that a different threshold value is used individually for the detection of the overload state and for the detection of the allowable load state. Hereinafter, the threshold in the former case is called an “overload threshold value” and that in the latter case is called an “allowable load threshold value”.

For example, the overload threshold value can be set to “90%” of a maximum data storage capacity of a memory section MEM and the allowable load threshold value can be set to “50%” of the maximum data storage capacity of the memory section MEM. Then, the load detecting section DECT of a transmission device B0 checks periodically the data storage capacity of the memory section MEM and compares the “checked value” with the “threshold value” set by the controller CTL.

When periodically consecutive detection by the comparison shows a change in its results from a content that the “checked value (data storage capacity)” is below the “overload threshold value (90%)” to the content that the “checked value (data storage capacity)” exceeds the “overload threshold value (90%)”, the load detecting section DECT of the transmission device B0 notifies the controller CTL of the transmission device B0 that the memory section MEM is in the overload state.

On the other hand, when the periodically consecutive detection by the comparison shows the change in its results from the content that the “checked value (data storage capacity)” exceeds the “overload threshold value (50%)” to the content that the “checked value (data storage capacity)” is below the “overload threshold value (50%)”, the load detecting section DECT of the transmission device B0 notifies the controller CTL of the transmission device B0 that the memory section MEM is in the allowable load state.

In the above first embodiment, the “same threshold value” is used for both the detection of the load state and for the detection of the allowable load state and, therefore, if the data storage capacity changes repeatedly in a boundary range of the threshold value, a problem arises that the switching between the duplex operation and the single and work-dividing operation is done so frequently. However, in the second embodiment, since the overload threshold value is used for the detection of the overload state individually and the allowable load threshold value is used for the detection of the allowable load state individually so that there is an allowance (torelance) in operations between the detection of the overload state and that of the allowable load state, even if the data storage capacity changes repeatedly in the boundary range of the threshold value, so long as the data storage capacity is below the allowable load state, there is no occurrence of the frequent switching between the duplex operation and the single and work-dividing operation. Therefore, according to the second embodiment, the frequent switching between the duplex operation and the single and work-dividing operation causing a decrease in communication quality can be avoided, thus achieving stable operations and providing an excellent communication environment.

Third Embodiment

Configurations and operations of a load dispersion-type duplex communication and duplex transmission device will be described. Configurations and operations of the third embodiment are the same as those in the first and second embodiments, but differ from those in the first and second embodiments in following points.

In the first embodiment, start and cancellation of a single and work-dividing operation is judged based on instantaneous data storage capacity at each time, however, in this third embodiment, a start and cancellation of the single and work-dividing operation is judged based on an amount of changes (mean rate of changes) in the data storage capacity within a predetermined period of time. That is, a threshold value is set to the “amount of changes (mean rate of changes) in the data storage capacity within the predetermined period of time” and following controls are made. This threshold value is called a “change rate threshold”.

A load detecting section DECT of a transmission device B0 checks periodically the data storage capacity of a memory section MEM, calculates the mean change rate of the data storage capacity within the predetermined period of time by using the “checked value” obtained every time the check is made and by using the “checked value” obtained from past predetermined number of time checks and compares the calculated change rate with the “change rate threshold” set by a controller CTL. Then, when the periodically consecutive detection by the comparison shows a change in its results from the content that the “calculated change rate (change rate of the data storage capacity)” is below the “change rate threshold value” to the content that the “calculated change rate (change rate of the data storage capacity)” exceeds the “change rate threshold”, load detecting section DECT of a transmission device B0 notifies the controller CTL of the transmission device B0 that the memory section MEM is in the overload state. 0n the other hand, when the periodically consecutive detection by the comparison shows the change in its results from the content that the “calculated change rate (change rate of the data storage capacity)” exceeds the “change rate threshold value” to the content that the “calculated change rate (change rate of the data storage capacity)” is below the “change rate threshold”, load detecting section DECT of the transmission device B0 notifies the controller CTL of the transmission device B0 that the memory section MEM is in the allowable load state.

When the number of times of calculating the mean value of the change rate is increased more, instantaneous change rate does not matter much and the operation is made stable accordingly.

In the above first embodiment, the “same threshold value” is used for both the detection of the overload state and for the detection of the allowable load state and, therefore, if the data storage capacity changes repeatedly in the boundary range of the threshold value, a problem arises that switching between the duplex operation and the single and work-dividing operation is done so frequently. However, in the third embodiment, start and cancellation of the single and work-dividing operation is judged based on the amount of changes of the data storage capacity within the predetermined period of time and, therefore, even if the data storage capacity changes repeatedly in the boundary range of the threshold, so long as the mean change rate is not below or does not exceed the change rate threshold value, there is no occurrence of the frequent switching between the duplex operation and the single and work-dividing operation. Therefore, according to the third embodiment, the frequent switching between the duplex operation and the single and work-dividing operation causing the decrease in communication quality can be avoided, thus achieving stable operations and providing an excellent communication environment.

It is apparent that the present invention is not limited to the above embodiments but may be changed and modified without departing from the scope and spirit of the invention.

What is claimed is:

1. A load dispersion-type duplex communication system comprising:
duplexed transmission devices;
wherein, whether each of said transmission devices is in an overload state or in an allowable load state is judged and said transmission device judged as being in said allowable load state performs a duplex operation with another transmission device and said transmission device being judged as being in said overload state performs a single and work-dividing operation with said other transmission device.

2. The load dispersion-type duplex communication system according to claim 1, wherein each of said transmission devices judges, for itself, whether each of said transmission devices is in said overload state or in said allowable load state and does automatically switching between said duplex operation and said single and work-dividing operation.

3. The load dispersion-type duplex communication system according to claim 1, wherein, whether said each of said transmission devices is in said overload state or in said allowable state is judged based on a data storage capacity of said each of said transmission devices.

4. The load dispersion-type duplex communication system according to claim 1, wherein a control is made in a manner to set an overload threshold value used to judge whether said each of said transmission devices is in said overload state or not and an allowable load threshold value used to judge whether said allowable load is below said overload threshold value or not.

5. The load dispersion-type duplex communication system according to claim 1, wherein, whether said each of said transmission devices is in said overload state or in said allowable state is judged based on an amount of changes in data storage capacity within a predetermined period of time in each of said transmission devices.

6. The load dispersion-type duplex communication system according to claim 1, wherein either of data processed by two said transmission devices performing said duplex operation is selected and processed by a low-order transmission device on a transmission path and wherein if judged to be in said overload state, data processed by two said transmission devices performing said single and work-dividing operation is multiplexed and processed by a low-order transmission device on said transmission path.

7. The load dispersion-type duplex communication system according to claim 6, wherein said each of said transmission devices is provided with a unit used to judge whether said each of said transmission devices is in said overload state or in said allowable load state and said each of said transmission devices, in accordance with a judgement by said each of said transmission devices, automatically does switching between said duplex operation and said single and work-dividing operation and then provides an instruction for said switching to another transmission device of a same order on a transmission path and a low-order transmission device on said transmission path.

8. The load dispersion-type duplex communication system according to claim 6, wherein, whether said each of said transmission devices is in said overload state or in said allowable state is judged based on a data storage capacity of said each of said transmission devices.

9. The load dispersion-type duplex communication system according to claim 6, wherein a control is made in a manner to set an overload threshold value used to judge whether said each of said transmission devices is in said overload state or not and an allowable load threshold value used to judge whether said allowable load is below said overload threshold value or not.

10. The load dispersion-type duplex communication system according to claim 6, wherein, whether said each of said transmission devices is in said overload state or in said allowable state is judged based on an amount of changes in data storage capacity within a predetermined period of time in each of said transmission devices.

11. A load dispersion-type duplex communication system comprising:
a received data selecting and multiplexing section;
a memory section used to store, on a temporary basis, data fed from said received data selecting and multiplexing section;
a transmission path interfacing section;
a load detecting section used to compare data amounts accumulated in said memory section with a threshold value and
a controller used to control each of said received data selecting and multiplexing section, said memory section, said transmission path interface section, and said load detecting section in accordance with results of the comparison by said load detecting section and to do switching between a duplex operation and single and work-dividing operation.
